(19) United States
(12) Patent Application Publication
(10) Pub. No.: US 2004/0184371 A1
(43) Pub. Date: Sep. 23, 2004

(54) Apparatus and method for playing optical disk

(75) Inventor: Tae-hee Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 10/765,876

(22) Filed: Jan. 29, 2004

(30) Foreign Application Priority Data
Feb. 3, 2003 (KR) 2003-6538

(51) Int. Cl. G11B 7/00

(52) U.S. Cl. 369/47.1

(57) ABSTRACT

An apparatus and method for playing an optical disk. The apparatus includes a first storage, a second storage, and a controller. The first storage stores a predetermined audio stream read out from an optical disk. The second storage stores still picture information corresponding to the audio stream. The controller outputs a still picture stored in the second storage, during an audio stream, corresponding to the still picture stored in the first storage, and, when index information of a target still picture is received from a user, compares the received index information with a maximum number of indexes included in a predetermined track of the optical disk currently playing and outputs a storage control signal based on the comparison result so that the second and first storages can store the index information of the target still picture and an audio stream, corresponding to the index information of the target still picture, respectively.

### CROSS-REFERENCE TO RELATED APPLICATIONS

This application claims the priority of Korean Patent Application No. 2003-6538, filed on Feb. 3, 2003, in the Korean Intellectual Property Office, the disclosure of which is incorporated herein in its entirety by reference.

### BACKGROUND OF THE INVENTION

1. Field of the Invention

The present invention relates to an apparatus and method for playing a DVD-Audio disk, and more particularly, to an apparatus and method for playing an optical disk, capable of arbitrarily setting and changing a playback location on each track of a disk on a still-picture-by-still-picture basis.

2. Description of the Related Art

There are different modes for reproducing still pictures stored on a DVD-Audio disk, including sequential slide show mode, where still pictures are output within a given amount of time defined in tracks of the DVD-Audio disk, random/shuffle slide show mode, where arbitrary still pictures are output within the given amount of time defined in the tracks of the DVD-Audio disk, sequentially browsable mode, where certain still pictures are output by a user's manipulation, and another mode where still pictures are arbitrarily output whenever there is a user's manipulation.

FIG. 1 is a flowchart of a conventional method of reproducing still pictures from a DVD-Audio disk in sequential slide show mode, and FIG. 2 is a diagram illustrating an index table created using navigation information.

Referring to FIG. 1, in operation 100, a host processor (not shown), which generally manages a DVD-Audio reproducer (not shown), compares current playback time, output from a DVD-Audio stream decoder (not shown), with navigation information, more specifically, index information, which is illustrated in FIG. 2 as a table, to search for a predetermined playback time that matches the current playback time. Here, the navigation information is information detected during a volume period at an early stage of playing a disk. If there is a perfect match for the current playback time in the index information, a still picture designated by an index corresponding to the predetermined playback time is output in operations 101 and 102. For example, referring to FIGS. 1 and 2, when current playback time is 00:01:12, the host processor compares the current playback time with the index information in order to search for a predetermined playback time that matches the current playback time and then outputs a still picture designated by an index corresponding to the predetermined playback time, i.e., index 2.

As described above, in the related art, it is possible to output a still picture corresponding to a desired playback time in sequential slide show mode through a time-based search. In the related art, however, it is impossible to provide a still-picture-based search, and thus a user cannot precisely search for his/her desired still pictures through a still-picture-based search.

### SUMMARY OF THE INVENTION

The present invention provides an apparatus for playing an optical disk, which is capable of arbitrarily setting and changing a playback location on each track of a disk on a still-picture-by-still-picture basis.

The present invention also provides a method for playing an optical disk, which is capable of arbitrarily setting and changing a playback location on each track of a disk on a still-picture-by-still-picture basis.

According to an aspect of the present invention, there is provided an apparatus for playing an optical disk, including a first storage, a second storage, and a controller. The first storage stores a predetermined audio stream read out from an optical disk. The second storage stores still picture information corresponding to the audio stream. The controller outputs a still picture, stored in the second storage during an audio stream, corresponding to the still picture stored in the first storage and, when index information of a target still picture is received from a user, the controller compares the received index information with a maximum number of indexes included in a predetermined track of the optical disk that is currently being played and outputs a storage control signal based on the comparison result, so that the second and first storages can store the index information of the target still picture and an audio stream corresponding to the index information of the target still picture, respectively.

According to an aspect of the present invention, the controller includes a comparator that compares the index information of the target still picture with the maximum number of indexes included in the predetermined track and outputs the storage control signal when the index information of the target still picture has a value not larger than the maximum number of indexes included in the predetermined track.

According to another aspect of the present invention, there is provided a method of playing an optical disk, which includes outputting a still image designated by a predetermined index during a predetermined audio stream reproduced from an optical disk; comparing index information of a target still picture with a maximum number of indexes included in a predetermined track of the optical disk currently being played when the index information of the target still picture is received from a user; and jumping from a current index to a predetermined index corresponding to the index information of the target still picture if the index information of the target still picture has a value not larger than the maximum number of indexes included in the predetermined track.

When jumping from a current index to a predetermined index corresponding to the index information, the target still picture indicated by the predetermined index is output, and simultaneously, an audio stream corresponding to playback time designated by the predetermined index is reproduced.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart of a conventional method of reproducing still pictures from a DVD-Audio disk in slide show mode;

FIG. 2 is a diagram illustrating an index table obtained from navigation information;

FIG. 3 is a block diagram of an apparatus for playing an optical disk according to an embodiment of the present invention; and

FIG. 4 is a flowchart of a method of playing an optical disk according to an embodiment of the present invention.

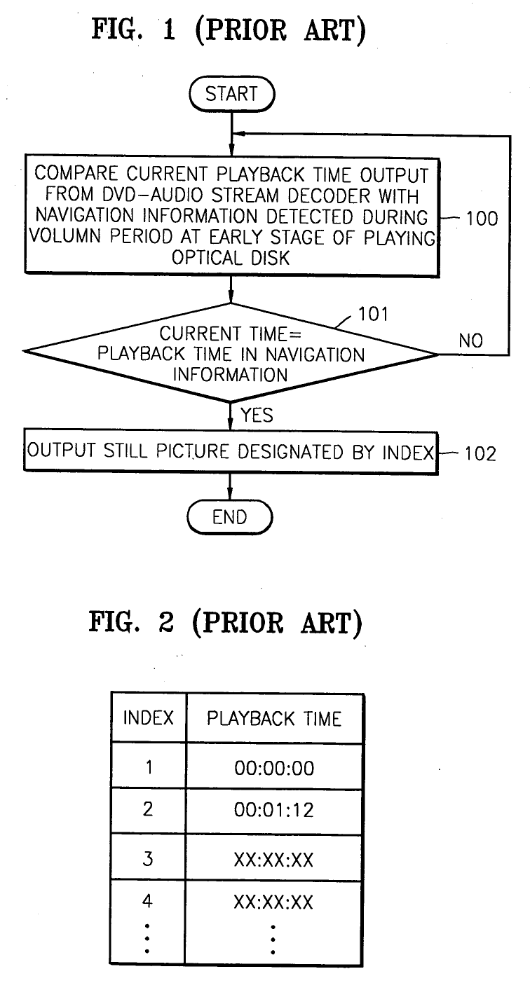

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

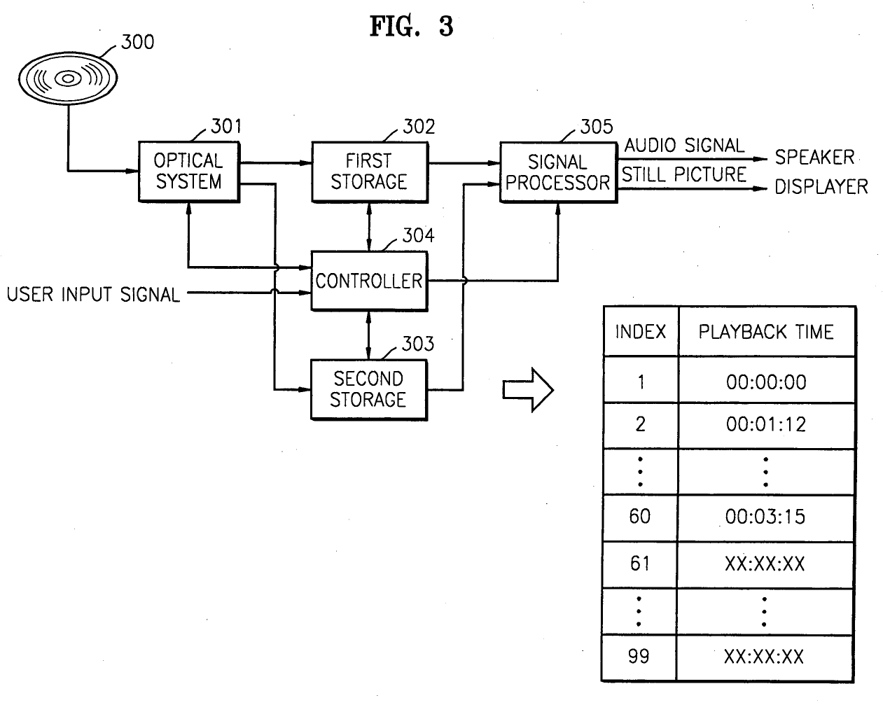

FIG. 3 is a block diagram of an apparatus for playing an optical disk according to an aspect of the present invention. Referring to FIG. 3, the apparatus includes a DVD-Audio disk 300, an optical system 301, a first storage unit 302, a second storage unit 303, a controller 304, and a signal processor 305.

In a predetermined area of the DVD-Audio disk 300, like other typical DVD-Audio disks, audio streams are stored. In other areas of the DVD-Audio disk 300, navigation information, including index information or indexes, playback times, and still pictures, are stored. A maximum of 99 still pictures can be included in each track of the DVD-Audio disk 300, and each still picture amounts to a maximum of 2 Mbytes. When playing a predetermined track of the DVD-Audio disk 300, still pictures included in the predetermined track are sequentially output on a time-basis.

The optical system 301 is a device for reading out signals from the DVD-Audio disk 300. An audio stream, read out from the predetermined track of the DVD-Audio disk 300, is stored in a buffer, i.e., the first storage 302, and navigation information for the predetermined track, read out from the predetermined track of the DVD-Audio disk 300, is stored in another buffer, i.e., the second storage 303.

While playing the predetermined track of the DVD-Audio disk 300, the controller 304 compares current playback time with the navigation information stored in the second storage 303 and outputs a still picture designated by a predetermined index when the current playback time matches playback time corresponding to the predetermined index. For example, current playback time at the very beginning of playing the predetermined track of the DVD-Audio disk 300 corresponds to 00:00:00. The controller 304 compares the current playback time with each playback time shown in an index table of FIG. 3 to search for a perfect match for the current playback time, i.e., 00:00:00. Then, the controller 304 controls a still picture designated by a predetermined index, i.e., index 1, corresponding to a searched playback time, to be output. Thereafter, when the current playback time is 00:01:12, the controller 304 compares 00:01:12 with each playback time in the index table to search for a perfect match for 00:01:12 and then controls a still picture designated by an index corresponding to a searched playback time, i.e., index 2, to be output.

While playing the predetermined track of the DVD-Audio disk 300, a user may directly input index information of a target still picture into the controller 304, for example, using page keys or direction keys provided onto a remote controller (not shown). Here, the target still picture is the one that the user desires to watch. When the controller receives the index information of the target still picture from the user, the controller 304 reads out the navigation information for the predetermined track from the DVD-Audio disk 300 and stores the read navigation information in the second storage 303. Thereafter, the controller 304 stores in the first storage, an audio stream corresponding to the navigation information stored in the second storage 303. To make this possible, the controller 304 may include a comparator (not shown). The comparator compares the received index information of the target still picture with a maximum number of still pictures included in the predetermined track, for example, 99. If the received index information has a value not larger than 99, the target still picture is stored in the second storage 303, and an audio stream corresponding to the index information of the target still picture is stored in the first storage 302.

For example, let us assume that a first track of the DVD-Audio disk 300 is played. At the very beginning of the playing, current playback time is 00:00:00. Then, the controller 304 searches for predetermined playback time in the navigation information for the first track of the DVD-Audio disk 300 that matches the current playback time by comparing the current playback time with the navigation information. Thereafter, the controller 304 controls a still picture designated by a predetermined index corresponding to the searched playback time, i.e., index 1, to be output. While playing the first track of the DVD-Audio disk 300, a user may input index information of any desired still picture other than the one currently being played into the controller 304, for example, using a remote controller. Here, the desired still picture could be on the predetermined track that is currently being played or another. Supposing that the index information that the user has input corresponds to index 61, the controller 304 receives index 61 from the user. Since the index 61 is not larger than the maximum number of still pictures in the first track of the DVD-Audio 300, for example, 99, the controller 304 reads a still picture corresponding to index 61 output from the DVD-Audio disk 300 and stores the read still picture in the second storage 303. At the same time, the controller 304 checks playback time designated by index 61, which is 00:03:15, reads audio stream data corresponding to the playback time from the DVD-Audio disk 300, and stores the audio stream data in the first storage 302.

The signal processor 305 processes signals so that the still picture stored in the second storage 303 and the audio stream data stored in the first storage 302 can be displayed or reproduced.

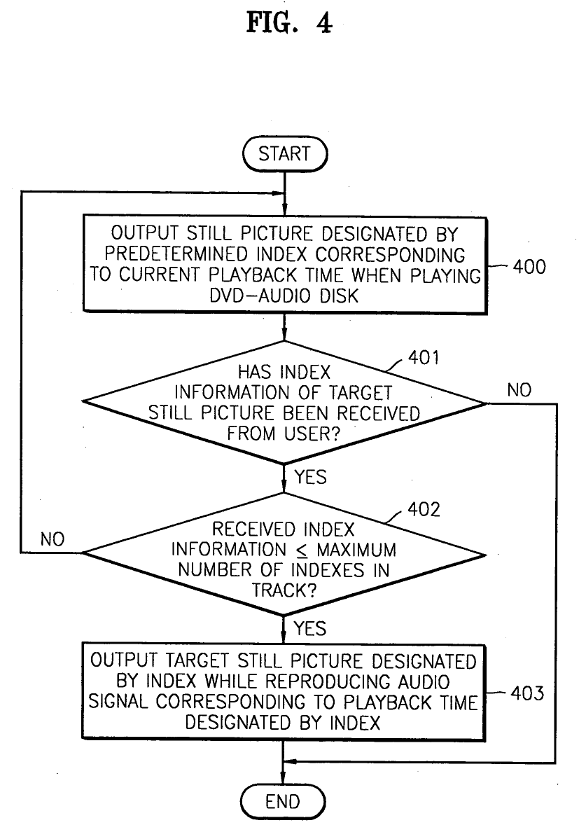

FIG. 4 is a flowchart of a method of playing an optical disk according to an aspect of the present invention. The method involves outputting a still picture designated by a predetermined index that corresponds to current playback time (operation 400) while playing a predetermined track of DVD-Audio disk; determining whether or not index information of a target still picture has been received from a user (operation 401); determining whether or not the received index information has a value not larger than a maximum number of still pictures included in the predetermined track (operation 402); and simultaneously reproducing a still picture designated by the received information and an audio signal corresponding to playback time designated by the received index information (operation 403).

More specifically, while playing a predetermined track of the DVD-Audio disk 300, the controller 304 outputs a still picture designated by a predetermined index corresponding to current playback time in operation 400. In other words, the controller 304 compares the current playback time with navigation information for the predetermined track, which is stored in the second storage 303. If there is a playback time that matches with the current playback time in the navigation information, the controller 304 outputs a still picture designated by the predetermined index corresponding to the playback time. For example, since current playback time at the very beginning of playing the predetermined track of the DVD-Audio disk 300 is 00:00:00, the controller 304 compares 00:00:00 with the navigation information for the predetermined track to identify an index that corresponds to the current playback time and then outputs a still picture designated by the index, i.e., index 1. Thereafter, at 00:01:12, the controller 304 compares current playback time, i.e., 00:01:12, with the navigation information and outputs a still picture designated by an index corresponding to 00:01:12, i.e., index 2.

Thereafter, in operation 401, the controller 304 determines whether index information of a target still picture that a user desires to watch has been received from the user. The user may input the index information of the target still picture into the controller 304, for example, using page keys or direction keys of a remote controller (not shown).

When the controller receives the index information of the target still picture from the user, the controller 304 determines in operation 402 whether the received index information has a value not larger than a maximum number of indexes included in the predetermined track. A maximum of 99, for example, still pictures can be included in each track of the DVD-Audio disk 300 as part of navigation information, and each still picture amounts to a maximum of 2 Mbytes.

If the received index information has a value not larger than the maximum number of indexes included in the predetermined track, the controller 403 outputs a still picture designated by the received index information and reproduces an audio signal corresponding to playback time indicated by the received index information in operation 403. For example, let us assume that the first track of the DVD-Audio disk 300 is played. At the very beginning of the playing, current playback time is 00:00:00. Then, the controller 304 searches for predetermined playback time in navigation information for the first track of the DVD-Audio disk 300 that matches with the current playback time by comparing the current playback time with the navigation information. Thereafter, the controller 304 controls a still picture designated by a predetermined index corresponding to the searched playback time, i.e., index 1, to be output. While playing the first track of the DVD-Audio disk 300, a user may input index information of any desired still picture other than the one currently being played into the controller 304, for example, using a remote controller. Here, the desired still picture could be on the predetermined track that is currently being played or another. Supposing that the index information that the user has input corresponds to index 61, the controller 304 receives index 61 from the user. Since index 61 is not larger than the maximum number of still pictures in the first track of the DVD-Audio 300, for example, 99, the controller 304 reads a still picture corresponding to the index 61 out from the DVD-Audio disk 300 and stores the read still picture in the second storage 303. At the same time, the controller 304 checks playback time designated by index 61, which is 00:03:15, reads audio stream data corresponding to the playback time from the DVD-Audio disk 300, and stores the audio stream data in the first storage 302. The signal processor 305 processes signals so that the still picture stored in the second storage 303 and the audio stream stored in the first storage can be displayed or reproduced.

As described above, according to the present invention, it is possible to arbitrarily set and change a playback location on each track of a disk on a still-picture-by-still-picture basis so that users' convenience can be maximized.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An apparatus for playing an optical disk, comprising:
a first storage storing a predetermined audio stream read out from an optical disk;
a second storage storing a target still picture corresponding to the predetermined audio stream; and
a controller outputting the target still picture stored in the second storage when index information of the target still picture is received from a user, by comparing the received index information with a maximum number of indexes included in a predetermined track of the optical disk currently being played and outputting a storage control signal based on the comparison result so that the second and first storages store the index information of the target still picture and the predetermined audio stream, corresponding to the index information of the target still picture, respectively.

2. The apparatus of claim 1, wherein the controller comprises a comparator comparing the index information of the target still picture with the maximum number of indexes included in the predetermined track and outputting the storage control signal when the index information of the target still picture has a value not larger than the maximum number of indexes included in the predetermined track.

3. A method of playing an optical disk, comprising:
outputting a still image designated by a predetermined index during a predetermined audio stream reproduced from an optical disk;
comparing index information of a target still picture with a maximum number of indexes included in a predetermined track of the optical disk currently playing when the index information of the target still picture is received from a user; and
jumping from a current index to a predetermined index corresponding to the index information of the target still picture if the index information of the target still picture has a value not larger than the maximum number of indexes included in the predetermined track.

4. The method of claim 3, wherein the jumping from a current index to a predetermined index corresponding to the index information of the target still picture comprises outputting the target still picture indicated by the predetermined index, and simultaneously reproducing an audio stream corresponding to playback time designated by the predetermined index.

5. A method of playing an optical disk in an optical disk player, comprising:
inputting index information of a still picture other than one currently being played;
comparing the input index information with a maximum number of still pictures in a first track of the optical disk;
reading a still picture from the optical disk, corresponding to the input index information if the input index is less than the maximum number of still pictures in the first track;
storing the read still picture;
checking playback time designated by the index information and reading audio stream data corresponding to the playback time from the optical disk;
storing the audio stream; and
reproducing the still picture and the audio stream if the input index is less than the maximum number of still pictures in the first track.

6. An apparatus for playing an optical disk, comprising:
a first storage storing an audio stream read from a predetermined track of the disk;
a second storage storing navigation information read from the predetermined track of the disk;
a controller comparing input index information with a maximum number of still pictures in a first track of the optical disk and reading a still picture from the optical disk, corresponding to the input index information if the input index information is less than the maximum number of still pictures in the first track; and
a processor processing signals so that the still picture and the audio stream are reproduced by the apparatus if the input index information is less than the maximum number of still pictures in the first track.

7. An apparatus for playing an optical disk, comprising:
arbitrarily setting and changing playback locations on tracks of the optical disk on a still-picture-by-still-picture basis.
